(19) United States
(12) Patent Application Publication
(10) Pub. No.: US 2021/0132987 A1
(43) Pub. Date: May 6, 2021

(54) COMPUTER PROGRAM FOR ASYNCHRONOUS DATA PROCESSING IN A DATABASE MANAGEMENT SYSTEM

(71) Applicant: TmaxData Co., Ltd., Seongnam-si (KR)

(72) Inventors: Juhyun Nam, Seongnam-si (KR); Sangyoung Park, Seongnam-si (KR)

(21) Appl. No.: 16/836,902

(22) Filed: Mar. 31, 2020

(30) Foreign Application Priority Data
Oct. 31, 2019 (KR) 10-2019-0137095

(51) Int. Cl. G06F 9/48; G06F 9/30; G06F 9/50; G06F 16/25; G06F 16/27

(52) U.S. Cl. CPC G06F 9/4881; G06F 9/3009; G06F 9/5027; G06F 2209/5022; G06F 16/25; G06F 16/273; G06F 2209/5018; G06F 9/5016

(57) ABSTRACT

Disclosed is a non-transitory computer readable medium storing a computer program, in which when the computer program is executed by one or more processors of a computing device, the computer program performs operation for asynchronous data processing in a database management system and the operations include: dividing an operation corresponding to a query into one or more tasks, if the query issued from a client is received; allocating a subtask for each of the one or more tasks to each of one or more worker threads; determining a balance of processing of the one or more tasks; and reallocating a subtask of a task related to an imbalance to a worker thread, if the processing of the one or more tasks is determined as the imbalance.

### CROSS-REFERENCE TO RELATED APPLICATIONS

This application claims priority to and the benefit of Korean Patent Application No. 10-2019-0137095 filed in the Korean Intellectual Property Office on Oct. 31, 2019, the entire contents of which are incorporated herein by reference

### FIELD OF THE INVENTION

The present disclosure relates to a database management system (DBMS), and more particularly, to a computer program for asynchronous data processing in a database management system.

### BACKGROUND

A database means a set of standard data integrated and managed so as to be shared and used by multiple persons. In general, data associated with a specific area of an organization is collected and may be used for providing information for supporting multiple levels of decision making.

As the amount of data becomes bigger today, a database management system (hereinafter referred to as DBMS) which efficiently supports retrieval or change of data in order to retrieve or change(insert, modify, delete, and update) data required in the database is increasingly being utilized.

The DBMS may store all data in a database in a table form. The table refers to a basic structure storing data in the database and one table is constituted by one or more records. When the DBMS receives a specific query from the outside, the DBMS performs functions such as selection, insertion, deletion, and update of data in the database according to the received query. Here, the query which refers to describing a predetermined request for the data stored in the table of the database, that is, what kind of operation is desired to be performed for the data may be expressed through a language such as a structured query language (SQL).

In the DBMS, a record is stored in a disk in the table form and the record is updated in response to the query from the outside (client or other application program). In this case, when one CPU processes one task corresponding to the outside query, a load may be large and a speed may decrease, and as a result, a data processing speed may be enhanced through a synchronous processing scheme by connecting multiple CPUs in parallel.

A synchronous processing scheme may mean that tasks are performed in series. Specifically, the synchronous processing scheme which sequentially executes the tasks is a scheme in which when a thread performs a specific task, a next task is allocated and made to wait and when the thread completes processing of the specific task, the next task that is waiting is processed.

However, when the tasks are sequentially performed through the synchronous processing scheme, a task processed in each thread is imbalanced according to a difference in data processing speed among a plurality of threads performing the task, and as a result, a specific thread may stay in a waiting state. This is inefficient in using a thread resource and may degrade a task processing speed.

Accordingly, in the DBMS, the task is asynchronously allocated to a plurality of threads according to a data flow to allow each thread to perform the task in balance, and as a result, there may be a demand for a computer program for increasing efficiency in resource utilization in the art.

### SUMMARY OF THE INVENTION

The present disclosure is contrived in response to the background art and has been made in an effort to provide a computer program for asynchronous data processing in a database management system.

An exemplary embodiment of the present disclosure provides a non-transitory computer readable medium storing computer program which is executable by one or more processors. When the computer program is executed by one or more processors, the computer program allows the one or more processors to perform operation for asynchronous data processing in a database management system, and the operations may include: dividing an operation corresponding to a query into one or more tasks, if the query issued from a client is received; allocating a subtask for each of the one or more tasks to each of one or more worker threads; determining a balance of processing of the one or more tasks; and reallocating a subtask of a task related to an imbalance to the worker thread, if the processing of the one or more tasks is determined as the imbalance.

Alternatively, in claim 1, the each of the one or more tasks may be a group of operations corresponding to the query, which are grouped by a predetermined basis, and the one or more tasks may form a relationship of at least one of a parallel processing relationship for processing data in parallel, or a dependency relationship for processing data in association.

Alternatively, if the one or more tasks form the dependency relationship, tasks forming the dependency relationship may include a master task for forwarding data generated according to a result of processing of the subtask to a slave task, and the slave task for performing an operation based on the data forwarded from the master task.

Alternatively, the allocating of a subtask for each of the one or more tasks to each of one or more worker threads may include: allocating a subtask of a master task to a worker thread to perform the master task of the one or more tasks; identifying at least one additional allocated worker thread for performing a slave task corresponding to the master task, if task progress for the master task is greater than or equal to a predetermined threshold; and allocating a subtask for the slave task to the additional allocated worker thread.

Alternatively, the additional allocated worker thread may be at least one of a worker thread performing a task corresponding to the master task, a worker thread with no subtask allocated, or a worker thread performing an operation corresponding to another query.

Alternatively, the determining of a balance of processing of the one or more tasks may include at least one of: determining the balance based on memory usage allocated to each of the one or more tasks; or determining the balance based on a task related message received from the one or more worker threads processing subtasks for each of the one or more tasks.

Alternatively, the determining of the balance based on memory usage allocated to each of the one or more tasks may include: determining that processing of the one or more tasks is imbalanced, if the memory usage allocated to each of the one or more tasks is greater than a predetermined first threshold usage; and determining that processing of the one or more tasks is imbalanced, if the memory usage for each dependency relationship formed by each of the one or more tasks is greater than a second predetermined threshold usage, and the memory usage for each dependency relationship may be identified by the sum of memory usage of each of the tasks included in each of a master task and slave task.

Alternatively, the determining of the balance based on a task related message received from the one or more worker threads processing subtasks for each of the one or more tasks may include: identifying a data processing result of each of the one or more tasks based on a task related message received from the one or more worker threads processing subtasks for each of the one or more tasks; and determining processing of the one or more tasks as imbalance, if a difference in data processing results between the one or more tasks is greater than a predetermined threshold.

Alternatively, the reallocating of a subtask of a task related to an imbalance to the worker thread, if the processing of the one or more tasks is determined as the imbalance may include: identifying an additional allocated worker thread for performing a subtask of a task related to the imbalance of the task; and allocating the subtask related to the imbalance to the additional allocated worker thread, and the additional allocated worker thread may be at least one of a worker thread performing the subtask related to the imbalance, a worker thread with no task allocated, or a worker thread performing an operation corresponding to another query.

Another exemplary embodiment of the present disclosure provides a method for asynchronous data processing in a database management system. The method may include: dividing an operation corresponding to a query into one or more tasks, if the query issued from a client is received; allocating a subtask for each of the one or more tasks to each of one or more worker threads; determining a balance of processing of the one or more tasks; and reallocating a subtask of a task related to an imbalance to the worker thread, if the processing of the one or more tasks is determined as the imbalance.

Still another exemplary embodiment of the present disclosure provides a server for performing asynchronous data processing in a database management system. The server may include: a processor including one or more cores; a storage unit including a memory storing program codes executable in the processor; and a network unit for transmitting and receiving data with a client terminal, and the processor may be configured to: if a query issued from the client is received, divide an operation corresponding to the query into one or more tasks; allocate a subtask for each of the one or more tasks to each of one or more worker threads; determine a balance of processing of the one or more tasks; and reallocate a subtask of a task related to an imbalance to a worker thread, if the processing of the one or more tasks is determined as the imbalance.

According to an exemplary embodiment of the present disclosure, a computer program for performing asynchronous data processing in a database management system can be provided.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a block diagram of a server according to an exemplary embodiment of the present disclosure.

FIG. 2 is a diagram schematically illustrating one or more tasks and subtasks corresponding to one query according to an exemplary embodiment of the present disclosure.

FIG. 3 is an exemplary diagram exemplarily illustrating tasks divided to correspond to one query according to an exemplary embodiment of the present disclosure.

FIG. 4 is an exemplary diagram schematically illustrating a process of performing tasks divided to correspond to one query according to an exemplary embodiment of the present disclosure.

FIG. 5 is an exemplary diagram exemplarily illustrating tasks divided to correspond to one query according to another exemplary embodiment of the present disclosure.

FIG. 6 is an exemplary diagram exemplarily illustrating tasks divided to correspond to one query according to still another exemplary embodiment of the present disclosure.

FIG. 7 is a flowchart for providing asynchronous data processing in a database management system according to an exemplary embodiment of the present disclosure.

FIG. 8 illustrates a module for performing asynchronous data processing in a database management system according to an exemplary embodiment of the present disclosure.

FIG. 9 illustrates a simple and general schematic view of an exemplary computing environment in which the exemplary embodiments of the present disclosure may be implemented.

### DETAILED DESCRIPTION

Various exemplary embodiments will now be described with reference to the drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to all of the case where X uses A, the case where X uses B, or the case where X uses both A and B. Further, it should be understood that the term “and/or” used in the specification designates and includes all available combinations of one or more items among related items enumerated .

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Furthermore, when not separately specified or it is not clear in terms of the context that a singular form is indicated, it should be construed that the singular form generally means “one or more” in the present specification and the claims.

Those skilled in the art need to additionally recognize that various illustrative logical blocks, configurations, modules, circuits, means, logic, and algorithm steps described in connection with the exemplary embodiments disclosed herein may be implemented as electronic hardware, computer software, or combinations of both sides. To clearly illustrate the interchangeability of hardware and software, various illustrative components, blocks, structures, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

In a database management system according to the present disclosure, asynchronous data processing may be implemented through a server 100.

A client may mean a predetermined type of node(s) having a mechanism for communication with the server 100. For example, the client may include a predetermined electronic device having connectivity with a personal computer (PC), a laptop computer, a workstation, a terminal, and/or the network. Further, the client may include a predetermined server implemented by at least one of agent, application programming interface (API), and plug-in.

According to an exemplary embodiment of the present disclosure, operations of the server 100 to be described below may be performed according to a query issued from the client.

The server 100 may include, for example, a predetermined type of computer system or computer device such as a microprocessor, a mainframe computer, a digital single processor, a portable device, and a device controller. The server 100 may include a database management system (DBMS). In addition, the server 100 may be used interchangeably with a device for executing a query.

The DBMS as a program for permitting the server 100 to perform operations including parsing of the query, retrieval, insertion, modification, and/or deletion of required data may be implemented by a processor 130 in a storage 120 of the server 100.

The server 100 may include a device including the processor 130 and the storage 120 for executing and storing commands as a predetermined type of database, but is not limited thereto. That is, the server 100 may include software, firmware, hardware, or a combination thereof. The software may include an application(s) for generating, deleting, and modifying database tables, schemas, indexes, and/or data. The server 100 may receive a transaction from the client or another computing device and exemplary transactions may include retrieving, inserting, modifying, deleting, and/or record management of the data, the table, and/or the index in the server 100.

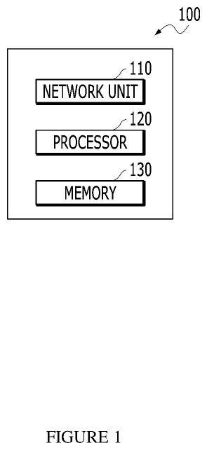

FIG. 1 is a block diagram of a server according to an exemplary embodiment of the present disclosure.

As illustrated in FIG. 1, the server 100 may include a network unit 110, a storage 120, and a processor 130. The aforementioned components are exemplary and the scope of the present disclosure is not limited to the aforementioned components. That is, additional components may be included or some of the aforementioned components may be omitted according to implementation aspects of exemplary embodiments of the present disclosure.

According to an exemplary embodiment of the present disclosure, the server 100 may include a network unit 110 transmitting and receiving data to and from the client. Further, the network unit 110 may provide a communication function with the server 100 and the client. The network unit 110 may receive an input from the client. For example, the network unit 110 may receive from the client requests related to storing, changing, and inquiring of data and changing and inquiring of building of the index. When the network unit 110 is located outside the server 100, the network unit 110 may receive from the server 100 an output table generated by performing an operation based on the received SQL for a specific table. Additionally, the network unit 110 may permit information transfer between the server 100 and the client in a scheme of invoking a procedure to the server 100. As an additional exemplary embodiment, the network unit 110 in the present disclosure may include a database link dblink, and as a result, the server 100 may communicate over the database link to receive data from another database server.

According to an exemplary embodiment of the present disclosure, the storage 120 may include a persistent storage and a memory.

The persistent storage may mean a non-volatile storage medium which may consistently store predetermined data, such as a storage device based on a flash memory and/or a battery-backup memory in addition to a magnetic disk, an optical disk, and a magneto-optical storage device. The persistent storage may communicate with the processor 130 and the memory of the server 100 through various communication means. In an additional exemplary embodiment, the persistent storage is positioned outside the server 100 to communicate with the server 100.

The memory as a primary storage device directly accessed by the processor, such as a random access memory (RAM) including a dynamic random access memory (DRAM), a static random access memory (SRAM), etc., may mean a volatile storage device in which stored information is momentarily erased when power is turned off, for example, but is not limited thereto. The memory may be operated by the processor 130. The memory may temporarily store a data table including a data value. The data table may include the data value and in an exemplary embodiment of the present disclosure, the data value of the data table may be written in the persistent storage from the memory. In an additional aspect, the memory may include a buffer cache and data may be stored in a data block of the buffer cache. The data stored in the buffer cache may be written in the persistent storage by a background process.

According to an exemplary embodiment of the present disclosure, the processor 130 may totally control an overall operation of the server 100. The processor 130 processes signals, data, information, etc., through the components described above or drives the application program stored in the storage 120 to perform operations for enhancing database management performance.

According to an exemplary embodiment of the present disclosure, the processor 130 may divide an operation corresponding to the query into one or more tasks. Specifically, the processor 130 may identify the operation corresponding to the query by receiving a query issued from the client and divide the operation corresponding to the query into one or more tasks.

The task is a group of operations corresponding to the query which are grouped by a predetermined basis, and respective tasks may form at least one relationship of a parallel processing relationship of processing data in parallel or a dependency relationship of linked processing data. Furthermore, the task may include one or more subtasks which are minimum units of processing of data processed in a worker thread. One or more subtasks may be minimum units which the worker thread may process in each task. For example, when the task is a task of scanning a record of a first table including 2000 rows, the task may include a first subtask of scanning a record of 1 to 1000 rows of the first table and a second subtask of scanning a record of 1001 to 2000 rows of the first table. A description of a specific numerical value for a scan range of each subtask described above is just an example and the present disclosure is not limited thereto.

In regard to the parallel processing relationship, a relationship in which a data processing relationship formed among the tasks may be a relationship in which data may be processed in parallel. For example, when the operation corresponding to the query is divided into a first task for a first table scan, a second task for a second table scan, and a third task of performing ordering for specific columns of the first table and the second table by the processor 130, a task of scanning respective tables may be performed in parallel. In other words, the first task and the second task may form the parallel processing relationship. A detailed description of each task is just an example and the present disclosure is not limited thereto.

The dependency processing relationship may be a relationship formed between tasks of linked-processing data and may include a master task and a slave task. The master task may be a task of forwarding a processing result of a subtask for each of one or more tasks to the slave task. Furthermore, the slave task may be a task of performing an operation based on data for the processing result of the master task. For example, when the operation corresponding to the query is divided into a first task for the first table scan, and a second task of performing merging of the records of a first column and a second column of the first table by the processor 130, processing the second task may be performed after processing the first task. In other word, the first task of scanning the first table and the second task of merging the records scanned through the first task may form a dependency processing relationship with each other. In this case, the first task may be the master task of forwarding data processed by the second task and the second task may be a slave task of performing an operation with data depending on the processing result of the first task as an input. A detailed description of each task is just an example and the present disclosure is not limited thereto.

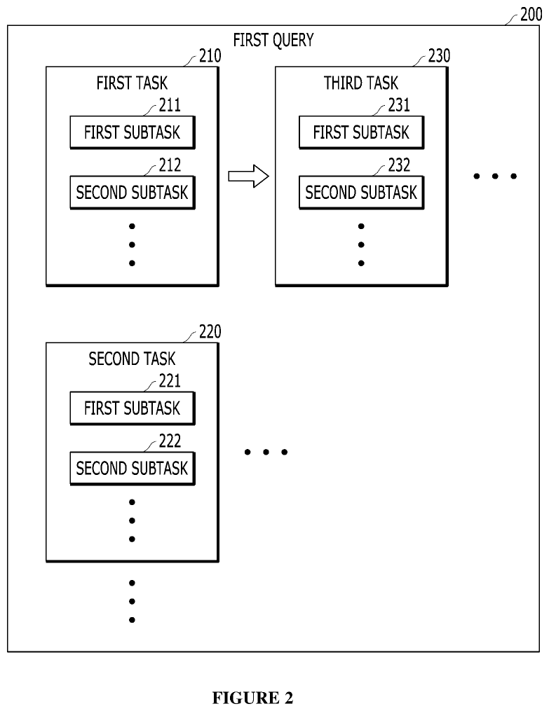

As a more specific example, when a first query 200 issued from the client is a query for ordering tables T1 and T2 based on a record of column C3, the processor 130 may divide the operation corresponding to the query into one or more tasks. Specifically, the processor 130 may divide an operation for the first query 200 into a first task 210 for scanning the record of table T1, a second task 220 for scanning the record of table T2, and a third task 230 of ordering the records scanned through the first task 210 and the second task 220 based on the records of the column C3 as illustrated in FIG. 2. The division may be performed based on an execution plan for the query.

In this case, the first task 210 and the second task 220 as tasks which scan each table may form the parallel processing relationship with each other. In other words, the first task 210 and the second task 220 of scanning the record of each of the tables T1 and T2 may be performed in parallel. Further, after a scan task for the record of each table is performed in the first task 210 and the second task 220, the third task 230 may be processed. The first task 210 of scanning table T1 and the third task 230 of merging the records scanned through the first task may form the dependency processing relationship with each other. Further, the second task 220 of scanning table T2 and the third task 230 of merging the records scanned through the second task may form the dependency processing relationship with each other. In other words, the first task 210 and the second task 220 may be the master tasks of forwarding the processed data (i.e., scanned record) to the third task 230 and the third task 230 may be the slave task of performing an operation for ordering based on data according to the processing results of the first task 210 and the second task 220.

Each of the first task 210, the second task 220, and the third task 230 divided by the processor 130 may include one or more subtasks. As illustrated in FIG. 2, the first task 210 may include a first subtask 211 for scanning records of rows 1 to 1000 in table T1 and a second subtask 212 for scanning records of rows 1001 to 2000 in table T1. Further, the second task 220 may include a first subtask 221 for scanning the records of rows 1 to 1000 in table T2 and a second subtask 222 for scanning the records of rows 1001 to 2000 in table T2. In addition, the third task 230 may include a first subtask 231 and a second subtask 232 for ordering the records scanned through the first task 210 and the second 220 by dividing sizes of the records of column C3 for each section. Specifically, the first subtask 231 of the third task 230 may be a subtask of performing ordering based on records 0 to 100 of column C3. Detailed descriptions of the query, the task, and the subtask described with reference to FIG. 2 are just examples for helping understanding of the present disclosure and the present disclosure is not limited thereto.

According to an exemplary embodiment of the present disclosure, the processor 130 may allocate the subtasks for one or more respective tasks to one or more worker threads, respectively. Specifically, the processor 130 may divide the operation corresponding to the query into one or more tasks and as one or more respective divided tasks form the parallel processing relationship or the dependency processing relationship, the respective tasks may be processed in parallel or processed dependently. Further, each of one or more tasks may include one or more subtasks which may be processed in parallel. In other words, the processor 130 allocates the subtask for each of one or more tasks to one or more worker threads, and as a result, the subtasks of each task may be performed in parallel.

For example, when the first task is a task of scanning the first table and the second task is a task of scanning the second table, the first task and the second task may be processed in parallel. Further, the first task may include a first subtask of scanning rows 1 to 100 of the first table and a second subtask of scanning rows 101 to 200 and the second task may include a first subtask of scanning rows 1 to 50 of the second table and a second subtask of scanning rows 51 to 100. In this case, subtasks included in each of the first task and the second task may be performed in parallel. In other words, simultaneously when the first task and the second task are processed in parallel, the subtasks corresponding to each task may also be processed in parallel. The detailed description of the task and the subtask is just an example and the present disclosure is not limited thereto.

In other words, the processor 130 divides the operation corresponding to the query into one or more tasks and the subtasks which may be processed in parallel for each of one or more tasks are allocated to one or more worker threads and processed in parallel to enhance a processing speed of the operation corresponding to the query.

According to an exemplary embodiment of the present disclosure, the processor 130 may allow the subtask for the slave task to be performed after the subtask for the master task is performed. Specifically, when one or more tasks form a dependency relationship, since the slave task performs the operation through data forwarded according to a performing result of the master task, the slave task should be performed at a time after the subtask for the master task is performed. As a result, the processor 130 may allocate the subtask for the slave task corresponding to the master task to one or more worker threads after processing data by allocating the subtask for the master task to one or more worker threads.

Specifically, the processor 130 may allocate the subtask of the master task to the worker thread in order to perform the master task among one or more tasks. Further, the processor 130 may identify at least one additional allocated worker thread for performing the slave task corresponding to the master task when a task progress for the master task is greater than or equal to a predetermined threshold. The additional allocated worker thread may be at least one of a worker thread of performing the task corresponding to the master task, a worker thread to which the subtask is not allocated, or a worker thread of performing an operation corresponding to another query. Further, the processor 130 may allocate the subtask for the slave task to the additional allocated worker thread.

In other words, the processor 130 may allocate the subtask for the slave task to the additional allocated worker thread and process the allocated subtask to correspond to a time (i.e., a time when the subtask for the slave task may be processed) when the subtask for the master task is processed as large as a predetermined threshold. Further, at least one of the worker thread of performing the subtask for the master task, the worker thread to which the subtask is not allocated, or the worker thread of performing the operation corresponding to another query is identified as the additional allocated worker thread to asynchronously allocate the task, thereby minimizing an idle worker thread.

Accordingly, the worker thread may be allocated to the subtask of each task at an optimal time at which each task may be processed, thereby facilitating a flow of data processing. Further, the subtask for the task is asynchronously processed by identifying the idle worker thread to increase efficiency of utilization of a worker thread resource.

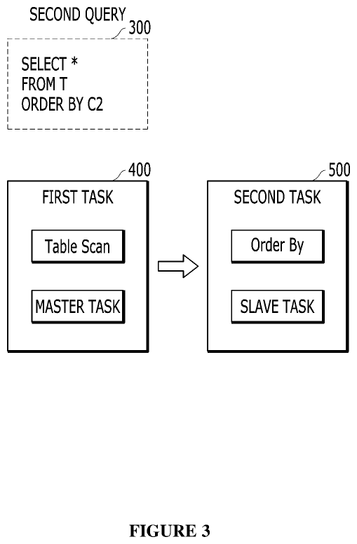

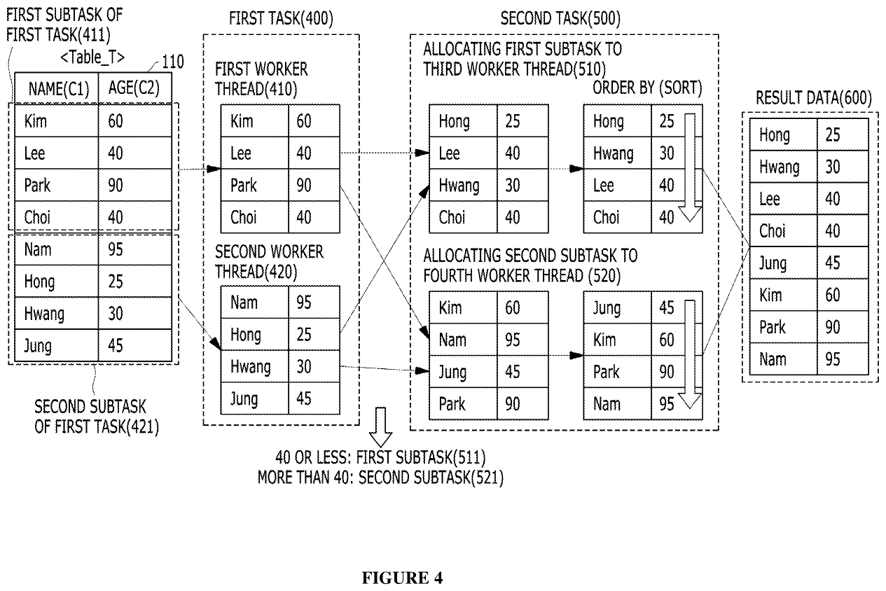

A more specific process in which the processor 130 allocates the subtasks for one or more respective tasks to one or more worker threads, respectively will be described below with reference to FIGS. 3 and 4.

As illustrated in FIG. 3, when the second query 300 issued from the client is a query for performing ordering (i.e., order by) for table T, the processor 130 may divide an ordering operation for table T into one or more tasks. Specifically, the processor 130 may identify that the operation corresponding to the second query 300 is an operation of ordering the record of each row based on a record positioned in column C2 in table T. The processor 130 may divide the operation corresponding to the second query 300 into a first task 400 for scanning the records of table T and a second task 500 for ordering the records identified through the first task based on the record of column C2. In this case, since the first task 400 forms the dependency relationship the performing result of the first task 400 corresponds to an input of the second task 500 with the second task 500, the first task 400 may be the master task and the second task 500 may be the slave task corresponding to the master task.

As illustrated in FIG. 4, the first task 400 may include a first subtask 411 for scanning records of rows 1 to 4 in table T and a second subtask 421 for scanning records of rows 5 to 8 in table T. The processor 130 allocates the first subtask 411 to the first worker thread 410 and allocates the second subtask 421 to the second worker thread 420 to perform respective subtasks in parallel. The processor 130 may forward a processing result (i.e., scanning the records of table T) of the first task (i.e., the master task 400) to the second task.

The second task (i.e., the slave task 500) which is receiving data for the processing result of the first task 400 may include a first subtask 511 for performing ordering based on records 0 to 40 of column C2 and a second subtask 521 for performing ordering based on records 41 or larger of column C2.

As illustrated in FIG. 4, the processor 130 may allocate the first subtask 511 of the second task 500 to the third worker thread 510 and allocate the second subtask 521 of the second task 500 to the fourth worker thread 520. In this case, the third worker thread 510 and the fourth worker thread 520 may be the additional allocated worker threads identified by the processor 130. In other words, the third worker thread 510 and the fourth worker thread 520 may be at least one of the worker thread (i.e., the first worker thread 410 or the second worker thread 420) for performing the master task, the worker thread (i.e., the idle worker thread) to which the subtask is not allocated, or the worker thread for performing the operation corresponding to another query.

The processor 130 may create a result table 600 illustrated in FIG. 4 based on data processed by performing the first subtask 511 and the second subtask 521 by each of the third worker thread 510 and the fourth worker thread 520. Specific numerical values for the task and the subtask described with reference to FIGS. 3 and 4 are just examples and it will be apparent to those skilled in the art that the present disclosure may include three or more tasks and subtasks.

In other words, the processor 130 may process subtasks for each of one or more tasks (i.e., the master task and the slave task) in parallel. As a result, the speed of data processing may be enhanced by performing the subtasks of each task in parallel and a load aggravated to performing of the subtask may be shared.

According to an exemplary embodiment of the present disclosure, the processor 130 may determine the balance of processing one or more tasks. The processor 130 may determine whether an inefficient state such as a bottleneck occurs in parallel processing of one or more tasks. The processor 130 may determine whether a progress of respective tasks is evenly performed and whether the bottleneck occurs. The processor 130 may determine the balance of processing one or more tasks based on a resource usage associated with the task, a progress state of the task, etc. Specifically, the processor 130 may determine a balance of data processing performed by each task based on at least one of a memory usage allocated to each of one or more tasks and a task related message received from one or more worker threads for processing the subtask for each of one or more tasks.

Specifically, the processor 130 may divide the operation corresponding to the query into one or more tasks. In this case, a memory capable of temporarily storing data may be allocated to each of one or more tasks and a data processing result of the subtask included in the task may be temporarily stored (i.e., buffered) in each memory.

The processor 130 may identify the memory usage allocated to each of one or more tasks. Further, the processor 130 may determine the balance of data processing performed in each of one or more tasks based on a comparison of a memory usage of each of one or more tasks and a predetermined threshold usage.

Specifically, when the memory usage allocated to each of one or more tasks exceeds a predetermined first threshold usage, the processor 130 may determine processing one or more tasks as an imbalance. The first threshold usage may be a criterion for determining whether data processing performed in each task is appropriate.

For example, when the operation corresponding to the query is divided into a first task for a first table scan and a second task for a second stable scan by the processor 130 and the memory usage of the first task is 20%, the memory usage of the second task is 70%, and the predetermined threshold usage is 65%, the processor 130 may determine the processing the task as the imbalance by identifying that the memory usage for the second task exceeds the predetermined first threshold usage.

As another example, when the operation corresponding to the query is divided into a first task for a table scan, a second task for performing hash join for the record of the scanned table, and a third task for applying a filter for a result of the second task by the processor 130, the memory usages of the respective tasks are 18%, 75%, and 12%, and the predetermined first threshold usage is 70%, the processor 130 may determine the processing the task as the imbalance by identifying that the memory usage for the second task exceeds the predetermined first threshold usage. A description of specific numerical values of the memory usage for each task and the predetermined first threshold usage is just an example and the present disclosure is not limited thereto.

When the memory usage for each dependency relationship formed by each of one or more tasks exceeds a predetermined second threshold usage, the processor 130 may determine processing one or more tasks as the imbalance. The memory usage for each dependency relationship may be a sum of memory usages of tasks included in each of the master task and the slave task. The second threshold usage may be a criterion for determining whether data processing between the master task and the slave task, i.e., the tasks forming the dependency relationship is appropriate.

As a specific example, when the operation corresponding to the query is divided into a first task for scanning the first table, a second task for scanning the second table, and a third task for ordering the records scanned through the first and second tasks by the processor 130, the memory usages of the respective tasks may be 40%, 55%, and 45% and the predetermined first threshold usage and the predetermined second threshold usage may be 70% and 90%, respectively. The first task and the second task may be master tasks for forwarding processed data to the third task and the third task may be a slave task for performing the operation based on the data processed in the master task. In this case, the memory usage for each dependency relationship may be identified as 95% through the sum of the memory usages of the first and second tasks which are the master tasks and identified as 45% through the memory usage of the third task which is the slave task. In other words, since the memory usage of each task does not exceed the predetermined first threshold usage (i.e., 75%), but the memory usage (95%) of the master task in the memory usage for each dependency relationship exceeds the predetermined second threshold usage (90%), the processor 130 may determine data processing performed in one or more tasks as the imbalance. A description of specific numerical values of the memory usage, the predetermined first threshold usage, and the predetermined second threshold usage for each task is just an example and the present disclosure is not limited thereto.

In other words, when a memory usage in a specific task exceeds a predetermined first threshold usage, the processor 130 may determine data processing performed in each of one or more tasks as an imbalance by determining that data processing in the specific task is in an inefficient state. Further, when the memory usage for each dependency relationship of each of the master task and the slave task exceeds the predetermined second threshold usage, the processor 130 may determine data processing performed in each of one or more tasks as the imbalance by determining that a bottleneck in which data is not processed and data processing is delayed in the formed dependency relationship occurs. For example, the above case may be determined as a case where processing the slave task is impossible because the master task is not performed.

The processor 130 may determine the balance of data processing performed in each of one or more tasks based on the task related message received from one or more worker threads for processing the subtask for each of one or more tasks. The task related message received from the worker thread may be a message related to processing completion for the subtask.

Specifically, the processor 130 may identify the data processing result of each of one or more tasks based on the task related message received from one or more worker threads. The data processing result of each task may indicate a degree at which the subtask is completed. Further, when a difference of data processing results of one or more respective tasks is smaller than or equal to a predetermined threshold, data processing performed in each of one or more tasks may be determined as the balance. Further, when the difference of data processing results of one or more respective tasks is more than the predetermined threshold, the processor 130 may determine the data processing performed in each of one or more tasks as the imbalance.

For example, the operation corresponding to the query may be divided into the first task for the first table scan and the second task for ordering the records scanned through the first task by the processor 130. Further, the predetermined threshold may be 700, and a task related message that scanning up to row 1000 is completed in the first table may be received from the worker threads for performing the subtasks for the first task and a task related message that ordering up to row 200 is completed may be received from the worker threads for performing the subtasks for the second task. In this case, the processor 130 may determine processing one or more tasks as the imbalance by identifying that the difference of the data processing results of the first and second tasks as 800 exceeds 700 which is the predetermined threshold. In other words, the processor 130 identifies that a scan task for the table is completed up to row 1000, but an ordering task for the scanned records is completed up to row 200 to determine that the bottleneck occurs in the record ordering task (i.e., the second task).

As another example, the operation corresponding to the query may be divided into the first task for the table scan, the second task for performing hash join for the record of the scanned table, and the third tasks for applying the filter for the result of the second task by the processor 130.

The predetermined threshold may be 500 and a task related message that scanning up to row 1000 is completed in the table may be received from the worker threads for performing the subtasks for the first task, a task related message that join is completed up to row 700 may be received from the worker threads for performing the subtasks for the second task, and a task related message that filter processing is completed up to row 20 may be received from the worker threads for performing the subtasks for the third task. In this case, the processor 130 may determine processing one or more tasks as the imbalance by identifying that the difference of the data processing results of the second and third tasks as 680 exceeds 500 which is the predetermined threshold. In other words, the processor 130 identifies that a join task is completed up to row 700, but a filter task for joined records is completed up to row 20 to determine that the bottleneck occurs in the filter task (i.e., the third task) for the joined records. A description of a specific numerical value of data processing for each task and a specific numerical value for the predetermined threshold is just an example and the present disclosure is not limited thereto.

In other words, the processor 130 may identify a data processing degree of each task through the task related message received from the worker threads for performing the subtask of each task and determine processing one or more tasks as the imbalance at a time when the processing degree of each task exceeds a predetermined threshold.

According to an exemplary embodiment of the present disclosure, when the processor 130 determines processing one or more tasks as the imbalance, the processor 130 may reallocate the subtasks for the task related with the imbalance to the worker thread. Specifically, the processor 130 may identify an additional allocated worker thread for performing the subtask of the task related to the imbalance of the task. The additional allocated worker thread may be at least one of a worker thread for performing the subtask for the task related to the imbalance, a worker thread to which the task is not allocated, or a worker thread for performing the operation corresponding to another query.

For example, when the operation corresponding to the query is divided into a first task for scanning the first table, a second task for scanning the second table, and a third task for ordering the records scanned through the first and second tasks by the processor 130, the memory usages of the respective tasks may be 80%, 55%, and 45% and the predetermined first threshold usage may be 75%. The processor 130 may identify that the task for scanning the first table exceeds the predetermined first threshold usage. In other words, the processor 130 may identify an additional allocated worker thread for performing the subtask of the third task by determining that data created by the processing result of the first task (i.e., the master task) is not consumed in the third task (i.e., the slave task). In this case, the additional allocated worker thread may be a worker thread for performing the subtask of the first task and a worker thread for performing the subtask of the second task.

The processor 130 may allocate the subtask of the third task (i.e., the slave task) which is the task related to the imbalance by identifying the worker thread for performing at least one of the subtasks of the first and second tasks corresponding to the master tasks as the additional allocated worker thread.

As a result, the worker thread of the master task for performing the task for the table scan may decrease and the worker thread of the slave task for performing the record ordering task may increase. Accordingly, since the processing speed for the subtask of the third task increases to consume the data processed in the first task, the memory usage of the first task may be reduced (i.e., data buffered by the processing result of the first task may be consumed through the third task). When the memory usage of the first task is reduced to be smaller than or equal to the predetermined first threshold usage, the processor 130 may perform the master task which is the scan for the table by allocating the subtasks of the first and second tasks to a worker thread to which the subtasks of the third task are allocated again by determining processing each task as the balance. A specific description of the memory usage of each task and the predetermined memory usage is just an example and the present disclosure is not limited thereto.

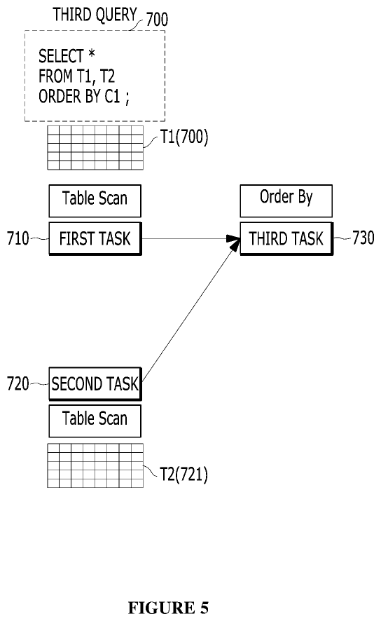

When more specifically described with reference to FIG. 5, when receiving the third query 700, the processor 130 may divide an operation of ordering tables T1 and T2 711 and 721 into one or more tasks based on the records of column C2. Specifically, the processor 130 may divide the tasks into a first task 710 for scanning records of table T1 711, a second task 720 for scanning records of table T2 721, and a third task 730 for ordering the records scanned through the first and second tasks 710 and 720 based on the records of column C1. In this case, since the first task 710 and the second task 720 forms the dependency relationship in which the performing result of the first task 710 and the second task 720 corresponds to an input of the third task 730 with the third task 730, the first task 710 and the second task 720 may be the master tasks and third task may be the slave task corresponding to the master task.

The first task 710 may include a first subtask for scanning records of rows 1 to 10 in table T1 711 and a second subtask for scanning records of rows 11 to 20 in table T1 711. Further, the second task 720 may include a first subtask for scanning records of rows 21 to 10 in table T2 721 and a second subtask for scanning records of rows 11 to 20 in table T2 721. Further, the third task 730 may include a first subtask for performing ordering based on records 0 to 10 of column C1 and a second subtask for performing ordering based on records 21 to 40 of column C1.

For example, when the memory usage of the second task 720 as 85% exceeds a predetermined first threshold usage (80%), the processor 130 may determine data processing of each task as the imbalance by identifying that data processed through first and second subtasks of the second task 720 is not consumed in the third task 730. As a result, the processor 130 may allocate the subtask of the third task to at least one worker thread of the worker threads for performing the first and second subtasks of the second task 710 for scanning table T2 721.

In other words, the processor 130 may allocate a third subtask (perform ordering based on records 41 or larger of column C1) of the third task 730 to at least one worker thread of the worker thread for completing execution of the first subtask of the second task 720 or the worker thread for completing execution of the second subtask of the second task 720. As the processor 130 reallocates the subtask of the third task 730 related to the imbalance to the worker thread for performing the subtask of the second task 720, the number of worker threads for performing the third task 730 may increase and the number of worker threads for performing the subtask of the second task 720 may decrease. In other words, a task having a large throughput is identified and the additional allocated worker thread is asynchronously identified in the corresponding task to be allocated to the subtask of the corresponding task, thereby preferentially processing data.

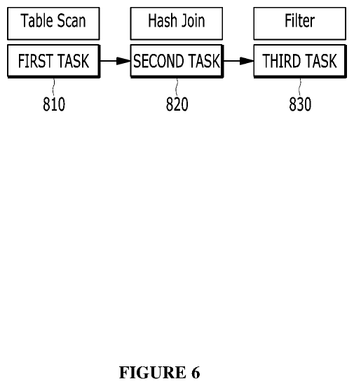

As another example, with reference to FIG. 6, when the operation corresponding to the query is divided into a first task 810 for a table scan, a second task 820 for performing hash join for the record of the scanned table, and a third task 830 for applying a filter for a result of the second task 820 by the processor 130, the memory usages of the respective tasks are 18%, 75%, and 12%, and the predetermined first threshold usage is 70%, the processor 130 may determine processing the task as the imbalance by identifying that the memory usage for the second task exceeds the predetermined first threshold usage. In other words, the processor 130 may identify an additional allocated worker thread for performing the subtask of the third task 830 in order to enhance the processing speed of the third task 830 by determining that data created by the processing result of the second task 820 is not consumed in the third task 830. In this case, the additional allocated worker thread may be a worker thread for performing subtasks of the first task 810 and the second task 820.

In other words, the processor 130 asynchronously allocates the subtask of the third task 830 to the worker thread for performing the subtask for the second task 820 related to the imbalance or the worker thread for performing the subtask of the first task 810 to enhance the processing speed of the third task 830, thereby rapidly consuming data buffered to the memory of the second task 820.

As a result, since the processing speed for the subtask for the third task 830 increases to consume data processed in the second task 820, the memory usage of the second task 820 may be reduced. In other words, since data buffered by the processing result of the second task 820 may be consumed due to enhancement of the processing speed of the third task, a bottleneck phenomenon may be resolved.

When the memory usage of the second task 820 is reduced due to enhancement of the processing speed of the third task 830 and the memory usage is smaller than or equal to the predetermined first threshold usage, the processor 130 determines processing each task as the balance to allocate the subtasks of the first task 810 and the second task 820 to the worker thread for allocating the subtask of the third task 830 again, thereby performing the task for the table scan or hash join.

Accordingly, the processor 130 does not perform a corresponding task by matching specific worker threads with each of one or more tasks but may efficiently perform data processing between respective tasks by asynchronously allocating a worker thread of another task or the idle worker thread when the bottleneck phenomenon occurs in a specific task according to a flow of data. In other words, flexible data processing is possible according to a processing situation of the task to enhance the speed of data processing corresponding to the query and rapidly resolve the bottleneck phenomenon which occurs in the specific task.

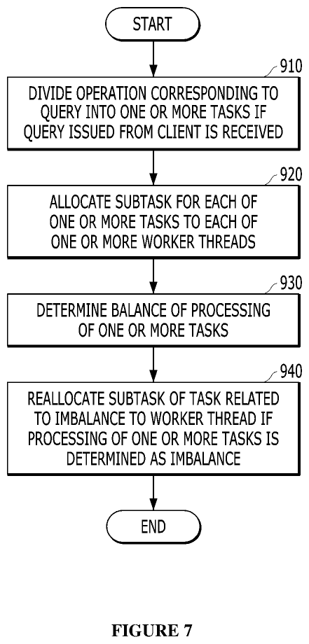

FIG. 7 is a flowchart exemplarily showing a method for asynchronous data processing in a database management system according to an exemplary embodiment of the present disclosure.

According to an exemplary embodiment of the present disclosure, when receiving a query issued from a client, the server 100 may divide an operation corresponding to the query into one or more tasks (910).

According to an exemplary embodiment of the present disclosure, the server 100 may allocate subtasks for one or more respective tasks to one or more worker threads, respectively (920).

According to an exemplary embodiment of the present disclosure, the server 100 may determine the balance of processing one or more tasks (930).

According to an exemplary embodiment of the present disclosure, when the server 100 determines processing one or more tasks as the imbalance, the processor 130 may reallocate the subtasks for the task related with the imbalance to the worker thread (940).

The steps of FIG. 7 described above may be changed in order if necessary, and at least one or more steps may be omitted or added. That is, the aforementioned steps are just an exemplary embodiment of the present disclosure and the scope of the present disclosure is not limited thereto.

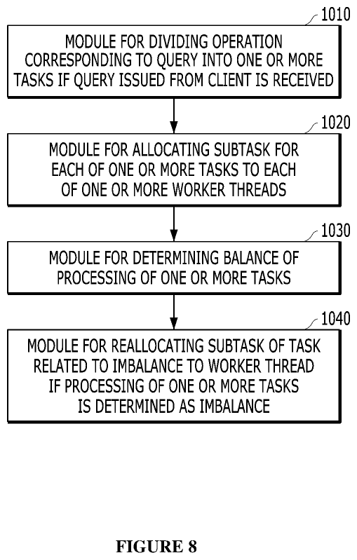

FIG. 8 illustrates a module for performing asynchronous data processing in a database management system according to an exemplary embodiment of the present disclosure.

According to an exemplary embodiment of the present disclosure, the server may be implemented by the following modules.

According to an exemplary embodiment of the present disclosure, when the server 100 receives a query issued from a client, the server 100 may include a module 1010 for dividing an operation corresponding to the query into one or more tasks, a module 1020 for allocating subtasks for each of the one or more tasks to one or more worker threads, respectively, a module 1030 for determining the balance of processing the one or more tasks, and a module 1040 for reallocating a subtask of a task related to the imbalance to a worker thread when processing the one or more tasks is determined as the imbalance.

Alternatively, in claim 1, each of the one or more tasks as a group for modules corresponding to the query, which are grouped by a predetermined basis may form at least one relationship of a parallel processing relationship of processing data in parallel or a dependency relationship of processing data in association.

Alternatively, if the one or more tasks form the dependency relationship, the tasks forming the dependency relationship may include a master task for forwarding data generated according to a result of processing the subtask to a slave task and the slave task for performing an operation based on the data forwarded from the master task.

Alternatively, the module for allocating the subtasks for each of the one or more tasks to one or more worker threads, respectively may include a module for allocating the subtask of the master task to a worker thread in order to perform the master task among the one or more tasks, a module for identifying at least one additional allocated worker thread for performing a slave task corresponding to the master task if a task progress for the master task is greater than or equal to a predetermined threshold, and a module for allocating the subtask for the slave task to the additional allocated worker thread.

Alternatively, the additional allocated worker thread may be at least one of a worker thread of performing the task corresponding to the master task, a worker thread to which the subtask is not allocated, or a worker thread of performing an operation corresponding to another query.

Alternatively, the module for determining the balance of processing the one or more tasks may include at least one module of a module for determining the balance of processing the one or more tasks based on the memory usage allocated to each of the one or more tasks or a module for determining the balance of processing the one or more tasks based on a task related message received from the one or more worker threads for processing the subtask for each of the one or more tasks.

Alternatively, the module for determining the balance of processing the one or more tasks based on the memory usage allocated to each of the one or more tasks may include a module for determining processing the one or more tasks as the imbalance when the memory usage allocated to each of the one or more tasks exceeds a predetermined first threshold usage and a module for determining processing the one or more tasks as the imbalance when a memory usage for each dependency relationship formed by the one or more respective tasks exceeds a predetermined second threshold usage and the memory usage for each dependency relationship may be identified as a sum of memory usages of respective tasks of included in each of the master task and the slave task.

Alternatively, the module for determining the balance of processing the one or more tasks based on the task related message received from one or more worker threads for processing the subtask for each of the one or more tasks may include a module for determining a data processing result of each of the one or more tasks based on the task related message received from the one or more worker threads for processing the subtask for each of the one or more tasks and a module for determining processing the one or more tasks as the imbalance when a difference of data processing results of the one or more tasks exceeds a predetermined threshold.

Alternatively, the module for reallocating the subtask of the task related to the imbalance to the worker thread when processing the one or more tasks is determined as the imbalance may include a module for identifying the additional allocated worker thread for performing the subtask of the task related to the imbalance of the task and a module for allocating the subtask related to the imbalance to the additional allocated worker thread and the additional allocated worker thread may be at least one of a worker thread for performing the subtask of the task related to the imbalance, a worker thread to which the task is not allocated, or a worker thread for performing an operation corresponding to another query.

According to an exemplary embodiment of the present disclosure, a module for performing asynchronous data processing in the database management system may be implemented by a means, a circuit, or a logic for implementing the server.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, components, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application, but such implementation decisions should not be interpreted as causing a departure from the scope of the present disclosure.

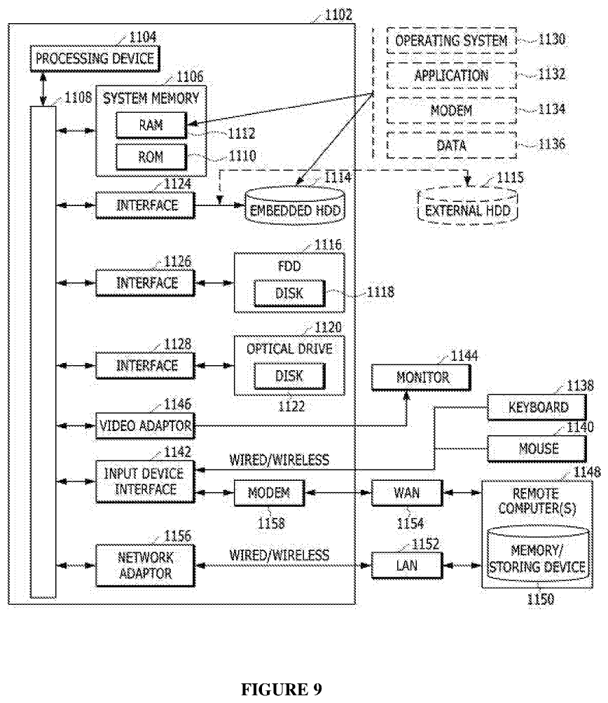

FIG. 9 illustrates a simple and general schematic view of an exemplary computing environment in which the exemplary embodiments of the present disclosure may be implemented.

The present disclosure has generally been described above in association with a computer executable instruction which may be executed on one or more computers, but it will be well appreciated by those skilled in the art that the present disclosure can be implemented through a combination with other program modules and/or a combination of hardware and software.

In general, the program module includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Any medium accessible by a computer may be a computer readable medium, and the computer readable medium may include a computer readable storage medium and a computer readable transmission medium. The computer readable storage includes volatile and nonvolatile media and movable and non-movable media. The computer readable storage media include volatile and non-volatile media and movable and non-movable media implemented by a predetermined method or technology for storing information such as a computer readable command, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally include information transfer media that implement the computer readable command, the data structure, the program module, or other data in a carrier wave or a modulated data signal such as other transport mechanism. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive 1114 may also be configured for an external purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch scene, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication server on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, an apparatus, or a standard programming and/or engineering technique. The term “manufactured article” includes a computer program, a carrier, or a medium which is accessible by a predetermined computer readable device. For example, a computer readable medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information. The term “machine-readable media” includes a wireless channel and various other media that can store, possess, and/or transfer instruction(s) and/or data, but is not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is consistent with the principles and new features presented herein.

What is claimed is:

1. A non-transitory computer readable medium storing a computer program, wherein when the computer program is executed by one or more processors of a computing device, the computer program performs operation for asynchronous data processing in a database management system, and the operations include:
dividing an operation corresponding to a query into one or more tasks if the query issued from a client is received;
allocating a subtask for each of the one or more tasks to each of one or more worker threads;
determining a balance of processing of the one or more tasks; and
reallocating a subtask of a task related to an imbalance to a worker thread, if the processing of the one or more tasks is determined as the imbalance.

2. The non-transitory computer readable medium according to claim 1, wherein the each of the one or more tasks are a group of operations corresponding to the query, which are grouped by a predetermined basis, and wherein the one or more tasks form a relationship of at least one of a parallel processing relationship for processing data in parallel, or a dependency relationship for processing data in association.

3. The non-transitory computer readable medium according to claim 2, wherein if the one or more tasks form the dependency relationship, tasks forming the dependency relationship include a master task for forwarding data generated according to a result of processing of the subtask to a slave task, and the slave task for performing an operation based on the data forwarded from the master task.

4. The non-transitory computer readable medium according to claim 1, wherein allocating a subtask for each of the one or more tasks to each of one or more worker threads, includes:
allocating a subtask of a master task to a worker thread to perform the master task of the one or more tasks;
identifying at least one additional allocated worker thread for performing a slave task corresponding to the master task, if task progress for the master task is greater than or equal to a predetermined threshold; and
allocating a subtask for the slave task to the additional allocated worker thread.

5. The non-transitory computer readable medium according to claim 4, wherein the additional allocated worker thread is at least one of a worker thread performing a task corresponding to the master task, a worker thread with no subtask allocated, or a worker thread performing an operation corresponding to another query.

6. The non-transitory computer readable medium according to claim 1, wherein the determining a balance of processing of the one or more tasks includes at least one of:
determining the balance based on memory usage allocated to each of the one or more tasks; or
determining the balance based on a task related message received from the one or more worker threads processing subtasks for each of the one or more tasks.

7. The non-transitory computer readable medium according to claim 6, wherein the determining the balance based on memory usage allocated to each of the one or more tasks, includes:
determining that processing of the one or more tasks is imbalanced, if the memory usage allocated to each of the one or more tasks is greater than a predetermined first threshold usage; and
determining that processing of the one or more tasks is imbalanced, if the memory usage for each dependency relationship formed by each of the one or more tasks is greater than a second predetermined threshold usage, and the memory usage for each dependency relationship is identified by the sum of memory usage of each of the tasks included in each of a master task and slave task.

8. The non-transitory computer readable medium according to claim 6, wherein the determining the balance based on a task related message received from the one or more worker threads processing subtasks for each of the one or more tasks, includes:
identifying a data processing result of each of the one or more tasks based on a task related message received from the one or more worker threads processing subtasks for each of the one or more tasks; and
determining that processing of the one or more tasks is imbalanced, if a difference in data processing results between the one or more tasks is greater than a predetermined threshold.

9. The non-transitory computer readable medium according to claim 1, wherein the reallocating a subtask of a task related to an imbalance, if the processing of the one or more tasks is determined as the imbalance, includes:
identifying an additional allocated worker thread for performing a subtask of a task related to the imbalance; and
allocating the subtask related to the imbalance to the additional allocated worker thread, and
wherein the additional allocated worker thread is at least one of a worker thread performing the subtask related to the imbalance, a worker thread with no task allocated, or a worker thread performing an operation corresponding to another query.

10. A method for asynchronous data processing in a database management system, including:
dividing an operation corresponding to a query into one or more tasks if the query issued from a client is received;
allocating a subtask for each of the one or more tasks to each of one or more worker threads;
determining a balance of processing of the one or more tasks; and
reallocating a subtask of a task related to an imbalance to a worker thread, if the processing of the one or more tasks is determined as the imbalance.

11. A server for performing asynchronous data processing in a database management system, including:
a processor including one or more cores;
a storage unit including program codes executable in the processor; and
a network unit for transmitting and receiving data with a client terminal, wherein the processor is configured to:
allocate a subtask for each of the one or more tasks to each of one or more worker threads;
determine a balance of processing of the one or more tasks; and
reallocate a subtask of a task related to an imbalance to a worker thread, if the processing of the one or more tasks is determined as the imbalance.
